(19) United States
(12) Patent Application Publication
(10) Pub. No.: US 2017/0169344 A1
(43) Pub. Date: Jun. 15, 2017

(54) METHODS, SYSTEMS, AND COMPUTER READABLE MEDIA FOR A DATA-DRIVEN DEMAND RESPONSE (DR) RECOMMENDER

(71) Applicant: The Trustees of the University of Pennsylvania, Philadelphia, PA (US)

(72) Inventors: Rahul Mangharam, Philadelphia, PA (US); Madhur Behl, Philadelphia, PA (US)

(21) Appl. No.: 15/380,058

(22) Filed: Dec. 15, 2016

Related U.S. Application Data
(60) Provisional application No. 62/267,817, filed on Dec. 15, 2015.

(51) Int. Cl. G06N 5/04

(52) U.S. Cl. CPC G06N 5/045

(57) ABSTRACT

Methods, systems, and computer readable media for a data-driven demand response (DR) recommender are disclosed. One system includes a processor and a memory. The system is configured to the system is configured to receive historical electricity usage information and historical weather information associated with at least one building, to generate at least one regression tree for predicting values associated with demand response (DR) related to the at least one building.

### PRIORITY CLAIM

The present application claims the benefit of U.S. patent application Ser. No. 62/267,817, filed Dec. 15, 2015, the disclosure of which is incorporated herein by reference in its entirety.

### GOVERNMENT INTEREST

This invention was made with government support under Grant No. 566112 awarded by the National Science Foundation. The government has certain rights in the invention.

### TECHNICAL FIELD

The subject matter described herein relates to power management. More particularly, the subject matter described herein relates to methods, systems, and computer readable media for a data-driven demand response (DR) recommender.

### BACKGROUND

Demand response (DR) typically is defined as changes in electricity usage based on or in response to the cost or demand of electricity over time. A DR system may involve allowing a user to adjust various aspects related to power (e.g., electricity) consumption in times of high demand (e.g., when electricity is more expensive). For example, an apartment complex or a factory may use significant amounts of electricity. In this example, a supervisor may use a DR system to minimize electricity usage in common areas during peak times when electricity costs are high. However, issues arise when attempting to predict the aggregate power consumption of a building, evaluating pre-determined DR strategies, and synthesizing new DR control strategies. For example, one issue involves accurately predicting how certain pre-determined DR strategies will affect cost savings and/or electricity usage for a particular building or environment.

Accordingly, there exists a need for improved methods, systems, and computer readable media for a data-driven demand response (DR) recommender.

### SUMMARY

Methods, systems, and computer readable media for a data-driven demand response (DR) recommender are disclosed. One system includes a processor and a memory. The system is configured to receive historical electricity usage information and historical weather information associated with at least one building, to generate at least one regression tree for predicting values associated with demand response (DR) related to the at least one building.

The subject matter described herein may be implemented in hardware, software, firmware, or any combination thereof. As such, the terms “function” or “node” as used herein refer to hardware, which may also include software and/or firmware components, for implementing the feature(s) being described. In some exemplary implementations, the subject matter described herein may be implemented using a computer readable medium having stored thereon computer executable instructions that when executed by the processor of a computer control the computer to perform steps. Exemplary computer readable media suitable for implementing the subject matter described herein include non-transitory computer readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

The subject matter described herein will now be explained with reference to the accompanying drawings of which:

FIG. 1 is a diagram illustrating a demand response (DR) advisor overview according to an embodiment of the subject matter described herein;

FIG. 2 is a diagram illustrating a DR event timeline;

FIG. 3 is a diagram illustrating a DR response baseline;

FIG. 4 is a diagram illustrating a DR strategy evaluation according to an embodiment of the subject matter described herein;

FIG. 5 is a diagram illustrating a data-driven DR baseline estimation using a DR advisor according to an embodiment of the subject matter described herein;

FIG. 6 is a diagram illustrating a data-driven DR strategy evaluation using a DR advisor according to an embodiment of the subject matter described herein;

FIG. 7 is a diagram illustrating mixed ordering of variables in a regression tree according to an embodiment of the subject matter described herein;

FIG. 8 is a diagram illustrating a separation of variables using a model based control with regression trees according to an embodiment of the subject matter described herein;

FIG. 9 is a flow chart illustrating using a model based control with regression trees for control synthesis according to an embodiment of the subject matter described herein;

FIG. 10 is a diagram illustrating DR synthesis with thermal constraints according to an embodiment of the subject matter described herein;

FIG. 11 is a flow chart illustrating a process for control synthesis according to an embodiment of the subject matter described herein;

FIG. 12 is a flow chart illustrating a process for DR strategy synthesis according to an embodiment of the subject matter described herein;

FIG. 13 is a diagram illustrating energy analytics architecture according to an embodiment of the subject matter described herein;

FIG. 14 depicts a high level block diagram of a computer system for performing various functions described herein; and

FIG. 15 is a flow chart illustrating a process for a data-driven DR recommender according to an embodiment of the subject matter described herein.

### DETAILED DESCRIPTION

The subject matter described herein relates to methods, techniques, and mechanisms for a data-driven demand response (DR) recommender. In accordance with some aspects of the subject matter described herein, a model based control with regression trees method (mbCRT) for performing various aspects of DR related procedures, including DR strategy synthesis and DR strategy evaluation. For example, a data-driven control synthesis method described herein can outperform rule-based DR by 17% for a large commercial reference building and can lead to a curtailment of 380 kilowatts (kW) and over $45,000 in savings. In some embodiments, various methods and/or techniques described herein can be integrated into a computing system, referred to herein as DR Advisor, for providing suitable control actions to meet a desired load curtailment while maintaining operations and maximizing the economic reward.

In accordance with some aspects of the subject matter described herein, a system, referred to herein as DR Advisor, is described herein for performing power (e.g., electricity) consumption predictions and for recommending DR related control actions for meeting a required load curtailment during a demand response event. For example, in order to obtain forecasts of the electricity consumption of a building, DR Advisor may use historical power consumption meter data, along with weather data, building set-point, and/or schedule information about heating, ventilation and air-conditioning (HVAC) systems in the building to learn or generate a family of regression trees. In this example, the family of regression trees may be generated using the following algorithms: CART, cross validated CART, boosted regression trees, random forest, and model based regression trees. The use of regression tree based data-driven models in problems of real-time demand response is novel.

In accordance with some aspects of the subject matter described herein, an approach for building auto-regressive trees is described herein for DR strategy evaluations. For example, regression trees or related data models may take into account the state of a building and weather forecasts to select a best DR strategy among several predetermined strategies. In this example, the selection a best DR strategy may involve a novel model based control with regression trees (mbCRT) method that enables control with regression trees use for real-time DR strategy synthesis. Using the mbCRT method, an optimally trade off thermal comfort inside the building against the amount of load curtailment may be determined. Continuing with this example, after regression trees or other data models are built, data analytics may be performed by running suitable filters across the data models. Such analytics may help a user (e.g., a building manager) to obtain a better understanding of how the building consumes energy.

Some aspects of the subject matter described herein may include predicting reliable aggregate power consumption forecasts for buildings in real-time using data driven models (e.g., regression trees) learned from historical data about weather, building set-points, and schedule information.

Some aspects of the subject matter described herein may include determining the best demand response control strategy from the set of pre-determined demand response strategies. For example, there could be several fixed rule based strategies at the disposal of the building's facilities manager and, using DR Advisor, determining the strategy which will lead to the best DR performance using data driven models (e.g., regression trees) learned from historical data about weather, building set-points and schedule information.

Some aspects of the subject matter described herein may include synthesizing new demand response strategies in real-time based on the current state of a building and the forecasts of the weather prediction using data driven models (e.g., regression trees) learned from historical data about weather, building set-points, and schedule information.

Some aspects of the subject matter described herein may include providing insightful analytics of building electricity consumption usage to a user (e.g., a facilities manager) using data driven models (e.g., regression trees) learned from historical data about weather, building set-points, and schedule information.

Some aspects of the subject matter described herein may include assisting curtailment service providers and demand response aggregators with a system to dispatch a better demand response request and optimizing the curtailment price being offered to the end-user for curtailment using the data driven models learned from historical data about weather, building set-points and schedule information.

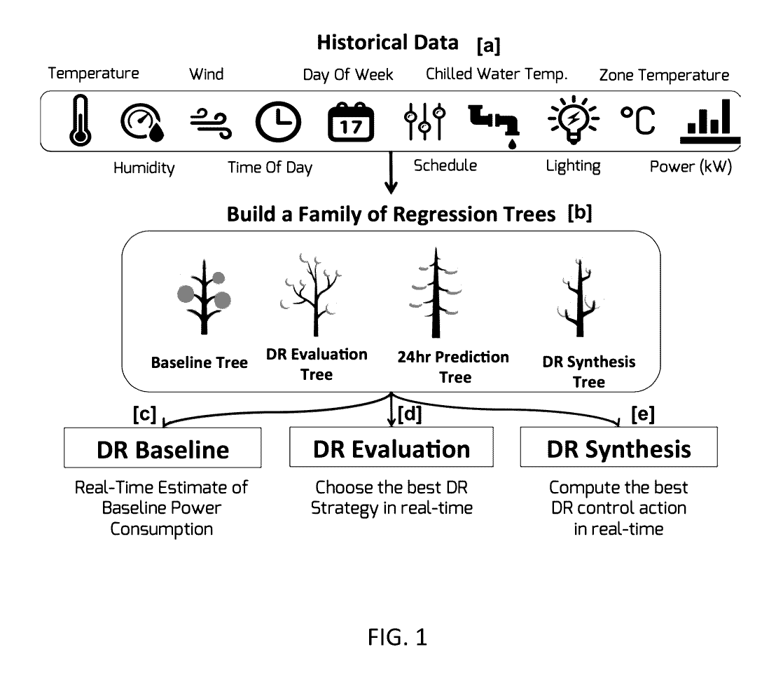

FIG. 1 is a diagram illustrating a demand response (DR) advisor overview according to an embodiment of the subject matter described herein. FIG. 1 depicts a method associated with a DR advisor (e.g., a system for performing DR related procedures). DR advisor may be any suitable entity, such as one or more computing devices or platforms, for performing one more aspects of the present subject matter described herein or in a manuscript entitled “DR-Advisor: A Data Driven Demand Response Recommender System;” the disclosure of the manuscript is incorporated herein by reference in its entirety.

In some embodiments, DR Advisor may utilize historical data (FIG. 1[a]) about the weather, schedule and sensor data from a building to generate a family of regression trees (FIG. 1[b]). Regression trees are mathematical models which may be usable for predicting the aggregate power consumption and zone temperatures of the building. These regression trees form the basis of the data-driven model which DR Advisor then uses to address the challenges associated with demand response baseline estimation (FIG. 1[c]), demand response strategy evaluation (FIG. 1[d]) and demand response strategy synthesis (FIG. 1[c]). These challenges are described in detail next.

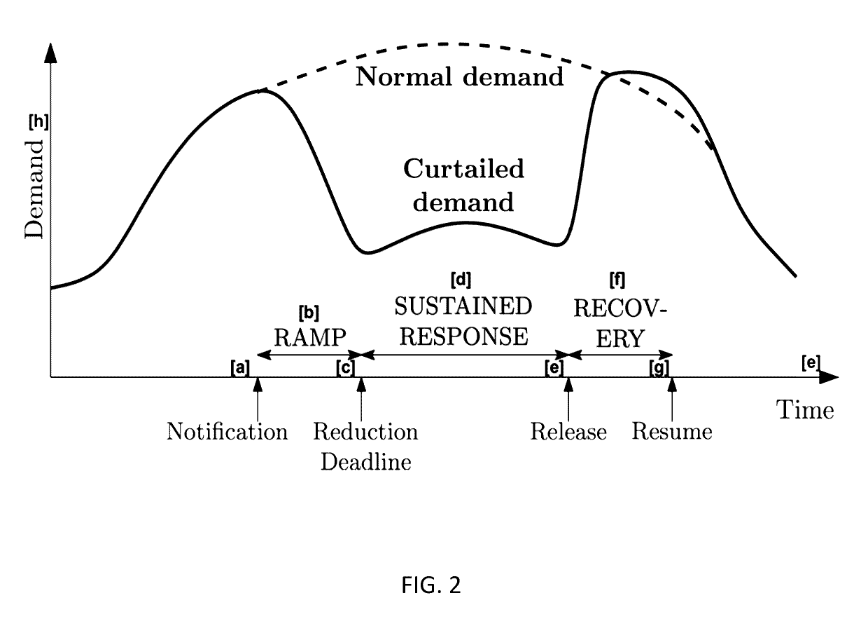

FIG. 2 is a diagram illustrating a DR event timeline. The y axis in FIG. 2 represents the demand of a building (FIG. 2[h]), while the x axis represents the progress of time (FIG. 2[e]). The time line of a typical DR event consists of three periods. The main period during which the demand needs to be curtailed is the sustained response period (FIG. 2[d]). The start of this period, e.g., the time by which the target reduction must be achieved, is the reduction deadline (FIG. 2[c]). Prior to that deadline, an event notification (FIG. 2[a]) is issued, at the notification time. The period between this time (FIG. 2[a]) and the reduction deadline (FIG. 2[c]) is the ramp period (FIG. 2[b]), during which the demand transitions from the normal level to the reduced level. The end of the sustained response period, e.g., the release time (FIG. 2[e]), is when the main curtailment is released, e.g., the load does not need to be curtailed anymore. It would take the demand side some time to resume the normal operation, during the recovery period (FIG. 2[f]). A possible phenomenon during this period is the DR rebound, when loads consume more electricity than normal to recover. Large DR rebound is undesirable, and DR strategies should be designed to mitigate this rebound. The DR event ends at the end of the recovery period when normal operation is resumed (FIG. 2[g]).

In some embodiments, DR Advisor or a related system may perform various functions when determining a DR strategy for providing a significant DR curtailment upon receiving a DR event notification. For example, DR Advisor may perform DR baseline predictions, DR strategy evaluations, and/or DR strategy synthesis.

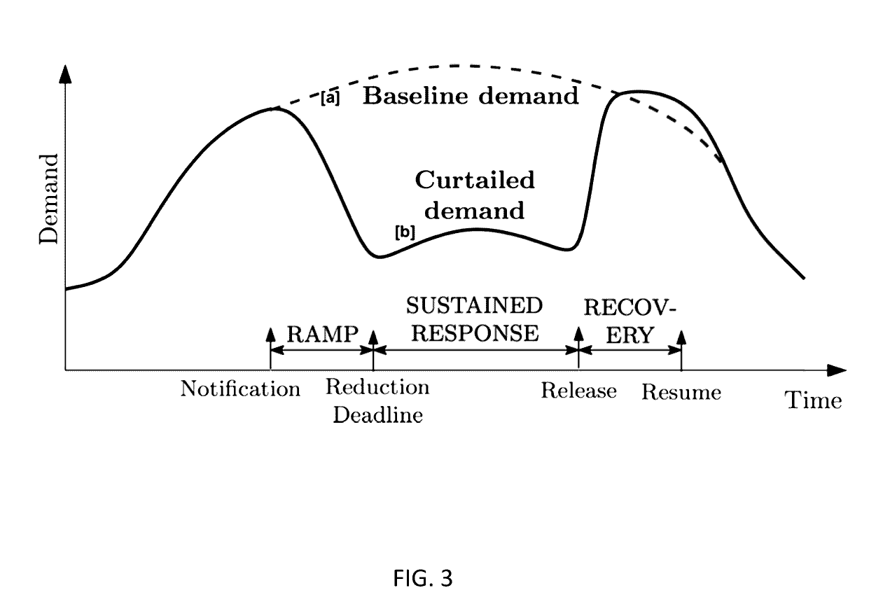

FIG. 3 is a diagram illustrating a DR response baseline. A DR baseline is an estimate of the electricity that would have been consumed by a customer in the absence of a demand response event. The baseline demand (FIG. 3[a]) is an estimate or a forecast of what a building's demand would have been had it not participated in a demand response event. The measurement and verification of the demand response baseline may be very useful for a DR related assessment since the amount of DR curtailment (FIG. 3[b]), and any associated financial reward can be determined with respect to the baseline estimate (FIG. 3[a]). In some embodiments, a predictive model g( )which relates a baseline power consumption estimate Ŷ_{base} to a forecast of the weather conditions and building schedule for the duration of the DR-event Ŷ_{base}=g( [symbol] , schedule) may be learnt or generated.

Demand response today is predominantly implemented manually and conducted using fixed rules and pre-determined curtailment strategies based on recommended guidelines, experience and best practices. A DR strategy refers to what control actions, and at what times, a system (lighting, HVAC or plug loads) will actuate. A strategy has one or more steps (control actions at times relative to the onset), and a time validity window for when it can be used. These pre-determined strategies can include adjusting zone temperature set-points, increasing supply air temperature and chilled water temperature set-point, dimming or switching off lights, and temporarily switching off equipment (escalators etc.). In a large building, it is difficult to asses the effect of one control action on the building sub-systems and on the overall power consumption because the sub-systems are tightly coupled. Moreover, the performance of any predetermined DR strategy will vary due to the environment conditions during the DR event. During a DR event, the building's facilities manager must choose a single strategy among several pre-determined strategies to achieve the required power curtailment. Each strategy includes adjusting several control knobs such as temperature set-points, lighting levels and temporarily switching off equipment and plug loads to different levels across different time intervals.

In such situations where one strategy can be used at a time, the question then is how to choose the DR strategy from a pre-determined set of strategies which leads to the largest load curtailment?

In some embodiments, DR Advisor or a related system may perform DR strategy evaluation for selecting a DR strategy from a pre-determined set of strategies which leads to the largest load curtailment. For example, instead of predicting the baseline power consumption Ŷ_{base} of a building, DR Advisor may predict an actual response of the building Ŷ_{kW} due to any given strategy.

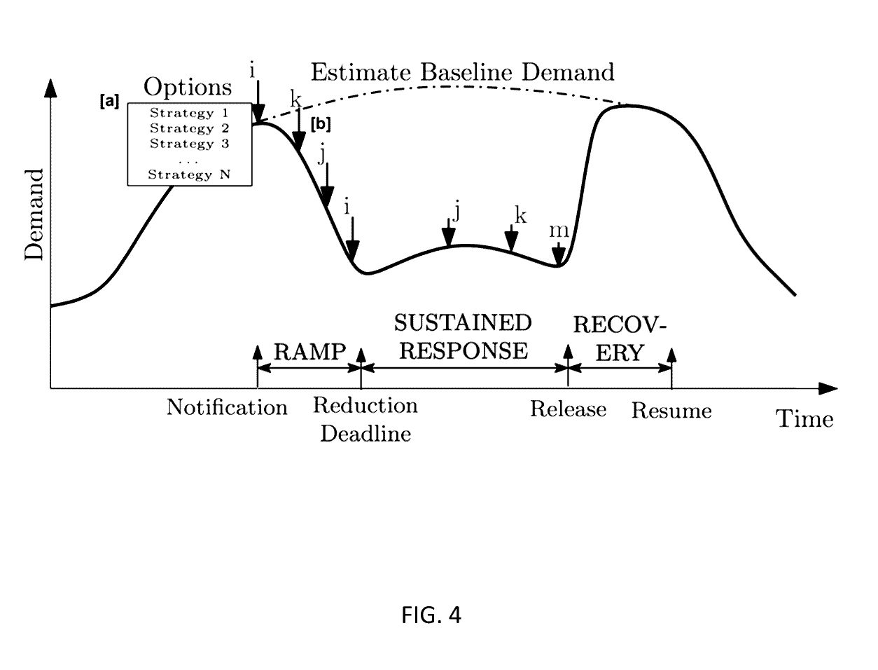

FIG. 4 is a diagram illustrating a DR strategy evaluation according to an embodiment of the subject matter described herein. In FIG. 4, there are N different pre-determined strategies (FIG. 4[a]) available, but at any time only one strategy may be implemented. DR Advisor may predict the power consumption of the building due to each strategy and chooses the DR strategy [i, j, k . . . N] which leads to the largest load curtailment (FIG. 4[b]). In some embodiments, the resulting strategy could be a combination of switching between the available set of strategies. This evaluation may be repeated throughout the event and in each instance the best DR strategy out of the pre-determined DR strategies is chosen.

In some embodiments, DR Advisor or a related system may perform DR strategy synthesis. For example, instead of choosing a DR strategy from a pre-determined set of strategies, a harder challenge is to synthesize new DR strategies and obtain optimal operating points for different DR related control variables.

This problem may be present as an optimization over the set of control variables, [symbol] _{c} such that

minimize [symbol] f(Ŷ_{kW}) Equation (1)

subject to
Ŷ_{kW=}h( [symbol] _{c})
[symbol] _{c} ∈ [symbol] _{safe}

To obtain an optimum strategy, the predicted power response of a buildingŶ_{kW}, may be minimized subject to a predictive model which relates to the response to control variables and subject to the constraints on the control variables. Unlike rule-base DR which do not account for building state and external factors, in DR synthesis the optimal control actions may be derived based on the current state of the building, forecast of outside weather, and electricity prices.

In order to build regression trees which can predict the power consumption of the building, we need to train on time-stamped historical data. The data that we use can be divided into three different categories as described below:

Weather Data: It includes measurements of the outside dry-bulb and wet-bulb air temperature, relative humidity, wind characteristics and solar irradiation at the building site.

Schedule data: We create proxy variables which correlate with repeated patterns of electricity consumption e.g. due to occupancy or equipment schedules. Day of Week is a categorical predictor which takes values from 1-7 depending on the day of the week. This variable can capture any power consumption patterns which occur on specific days of the week. For instance, there could a big auditorium in an office building which is only used on certain days. Likewise, Time of Day is quite an important predictor of power consumption as it can adequately capture daily patterns of occupancy, lighting and appliance use without directly measuring any one of them. Besides using proxy schedule predictors, actual building equipment schedules can also be used as training data for building the trees.

Building data: The state of the building is required for DR strategy evaluation and synthesis. This includes (i) Chilled Water Supply Temperature (ii) Hot Water Supply Temperature (iii) Zone Air Temperature (iv) Supply Air Temperature (v) Lighting levels.

DR Advisor may utilize a mix of several methods to learn a reliable baseline prediction model. For each method, we train the model on historical power consumption data and then validate the predictive capability of the model against a test data-set which the model has never seen before. In addition to building a single regression tree, we also learn cross-validated regression trees, boosted regression trees (BRT) and random forests (RF). The ensemble methods like BRT and RF help in reducing any over-fitting over the training data. They achieve this by combining the predictions of several base estimators built with a given learning method in order to improve generalizability and robustness over a single estimator.

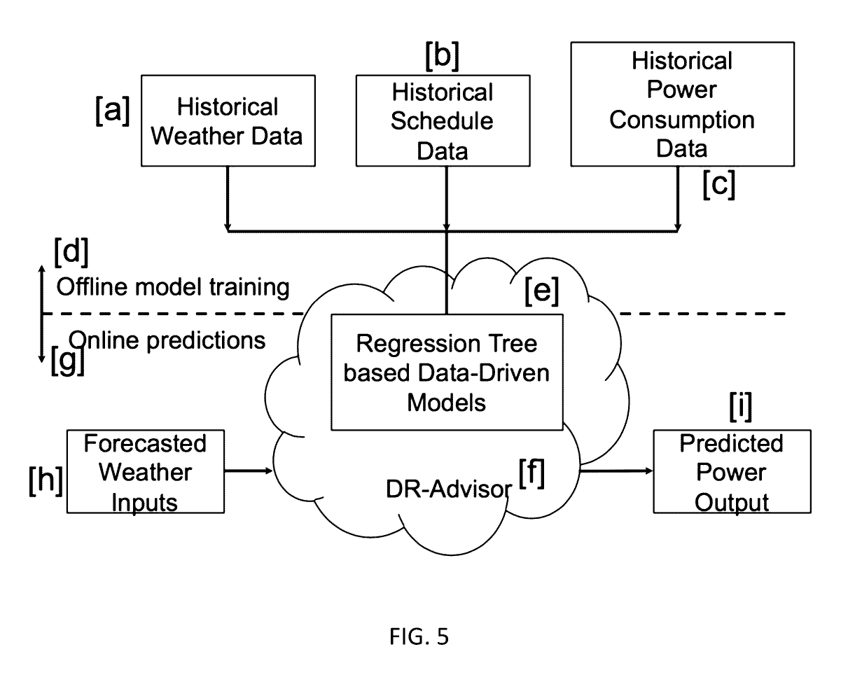

FIG. 5 is a diagram illustrating a data-driven DR baseline estimation using a DR advisor according to an embodiment of the subject matter described herein. In FIG. 5, historical data about weather (FIG. 5[a]), such as outside dry and wet bulb air temperature, relative humidity, dew point temperature, wind speed, wind direction, wind gusts, solar irradiation, precipitation, cloud cover etc. may be obtained. Historical power consumption data (FIG. 5[c]) and any historical building operation schedule data (FIG. 5[b]) may also be obtained. This data may then be used to learn several regression trees based data-driven models (FIG. 5[e]). This is the part of the offline learning process (FIG. 5[d]). During the event, DR Advisor (FIG. 5[f]) may use a forecast of weather conditions (FIG. 5[h]) for the DR event duration to make predictions of the power consumption of the building/system (FIG. 5[i]).

In some embodiments, regression tree models for DR strategy evaluation may be similar to models used for DR baseline estimation except for two differences. First, instead of only using weather and proxy variables as the training features, in DR evaluation, set-point schedules and sensor data from the building itself may be accounted for to capture the influence of the state of the building on its power consumption. Second, in order to predict the power consumption of the building for the entire length of the DR event, auto-regressive trees may be utilized. An auto-regressive tree model is a regular regression tree except that the lagged values of the response variable are also predictor variables for the regression tree, e.g., the tree structure is learned to approximate the following function:

Ŷ_{kW}(t)=f([X₁, X₂, . . . , Xₘ, Y_{kW}(t−1), . . . , Y_{kW}(t−δ)]) Equation (2)

where the predicted power consumption response Ŷ_{kW}(t) at time t, depends on previous values of the response itself [Y_{kW}(t−1), . . . , Y_{kW}(t−δ)] and δ is the order of the auto-regression. As such, finite horizon predictions of power consumption for the building may be determined.

At the beginning of the DR event, an auto-regressive tree for predicting the response of the building due to each rule-based strategy may be used and the one which performs the best over the predicted horizon may be selected. The prediction and strategy evaluation may be recomputed periodically throughout the event

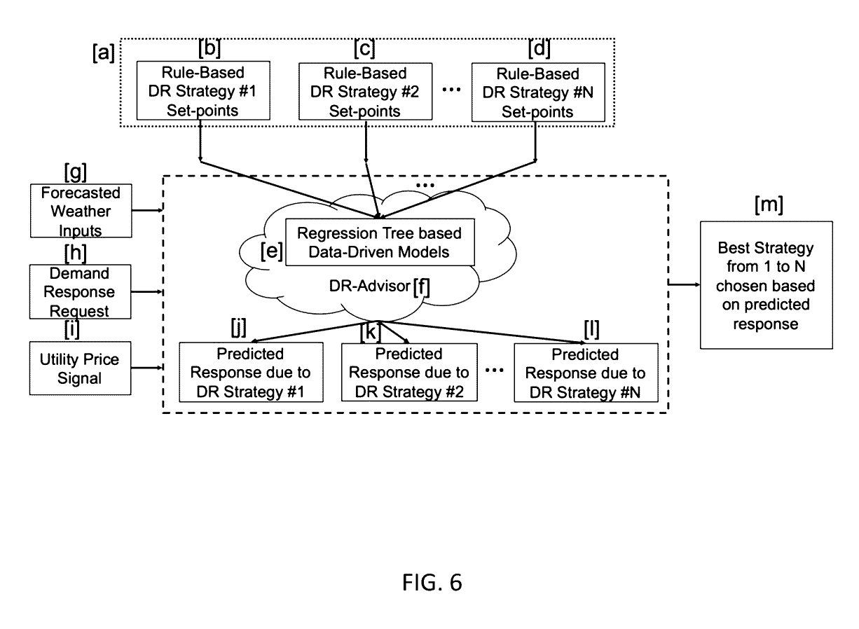

FIG. 6 is a diagram illustrating a data-driven DR strategy evaluation using a DR advisor according to an embodiment of the subject matter described herein. For DR strategy evaluation, a set of pre-determined or fixed rule based DR strategies (FIG. 6[a]) may be used. Each strategy may comprise of some control actions which will be implemented onto the building when the demand response event begins. Examples of these control actions include changing the chilled water temperature set-point, changing the zone air temperature set-point, changing the supply air temperature set-point, changing the lighting set-point, changing the static set-point pressure set-point, switching off heating ventilation and air conditioning devices etc. There could be several such strategies: rule-based DR strategy #1 (FIG. 6[b]), rule-based DR strategy #2 (FIG. 6[c]), and so on up to rule-based DR strategy #N (FIG. 6[d]). These strategies serve as inputs to the regression tree based data-driven models learned prior to the DR evaluation (FIG. 6[e]). Along with the pre-determined strategies, DR Advisor (FIG. 6[f]), uses a forecast of the weather conditions (FIG. 6[g]), details of the demand response curtailment request (FIG. 6[h]) and the real-time price of electricity (FIG. 6[i]). Using all these inputs, DR Advisor may the power consumption and thermal response of a building due to each DR strategy (FIG. 6[j]) to (FIG. 6[l]). The power consumption response refers to the predicted power consumption of the building while the thermal response refers to the level of thermal comfort inside the building due to the strategy.

In some embodiments, after obtaining N different predictions, one for each pre-determined DR strategy, DR Advisor may select the best rule amongst the set of pre-determined rules, e.g., the rule which leads to the larges curtailment but bounded by thermal comfort (or discomfort).

In some embodiments, enabling control synthesis for regression trees includes the separation of features and/or variables into manipulated and non-manipulated features. In the case of buildings, the set of variables can be separated into disturbances (or non-manipulated) variables like outside air temperature, humidity, wind, etc. while the controllable (or manipulated) variables can be the temperature and lighting set points within the building. In some embodiments, regression tree based methods may be developed for synthesizing optimal values of the control variables in real-time.

For example, let [symbol] _{c} ⊂ [symbol] denote the set of manipulated variables and [symbol] _{d} ⊂ [symbol] denote the set of disturbances/non-manipulated variables such that [symbol] _{c} ∪ [symbol] _{d}≡ [symbol] , where [symbol] is the set of all variables of features required for prediction.

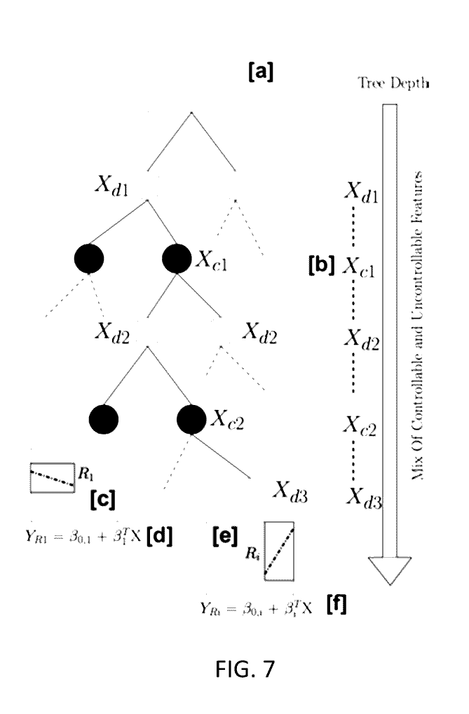

FIG. 7 is a diagram illustrating mixed ordering of variables in a regression tree according to an embodiment of the subject matter described herein. FIG. 7 shows an example of how manipulated and non-manipulated features can get distributed at different depths of model based regression tree which uses a linear regression function in the leaves of the tree. The root node at the top of the regression tree (FIG. 7[a]) represents the entire feature/variable space. The structure of the tree partitions the feature space into several regions. Within each region, at the leaf nodes of the tree, there is linear regression model which relates the predicted response to the values of all the features.

[symbol]

=β_{0,i}+αᵢ^{T}

[symbol]

where Y_{Ri}, is the predicted response in region Rᵢ of the tree using all the features [symbol] . In such a tree the prediction can only be obtained if the values of all the features, [symbol] , is known, including the values of the control variables [symbol] _{c}.

Since the manipulated and non-manipulated variables appear in a mixed order in the tree depth, we cannot use this tree for control synthesis.

This is because the value of the control variables [symbol] _{c}, is unknown, one cannot navigate to any single region using the forecasts of disturbances alone.

We develop a model-based control with regression trees (mbCRT) method, which avoids this problem using a clever idea. We still partition the entire data space into regions using a regression tree method such as CART, but the top part of the regression tree is learned only on the non-manipulated features [symbol] _{d} or disturbances as opposed to all the features [symbol] .

In every region at the leaves of the “disturbance” tree a linear model is fit but only on the control variables:

[symbol]

=β_{0,i}+βᵢ^{T} [symbol] _{c}

Separation of variables allows us to use the forecast of the disturbances [symbol] to navigate to the appropriate region Rᵢ and use the linear regression model with only the control/manipulated features in it as the valid prediction model for that time-step.

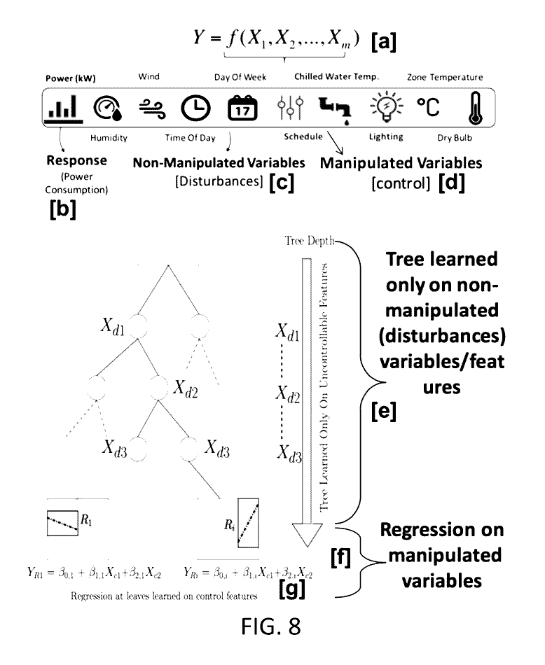

FIG. 8 is a diagram illustrating a separation of variables using a model based control with regression trees according to an embodiment of the subject matter described herein. FIG. 8 shows a tree constructed using the separation of variables principle. The set of all features [symbol] , (FIG. 8[a]), comprises of the response variable, Y (FIG. 8[b]), non-manipulated or disturbance variables [symbol] _{d} (FIG. 8[c]) and manipulated or control variables [symbol] _{c} (FIG. 8[d]). The top part of the tree up to the leaf nodes is learned only on the non-manipulated variables (FIG. 8[e]) while at the leaves of the tree (FIG. 8[f]), a linear regression model between the response variables and the manipulated variables (control features) is fitted (FIG. 8[g]).

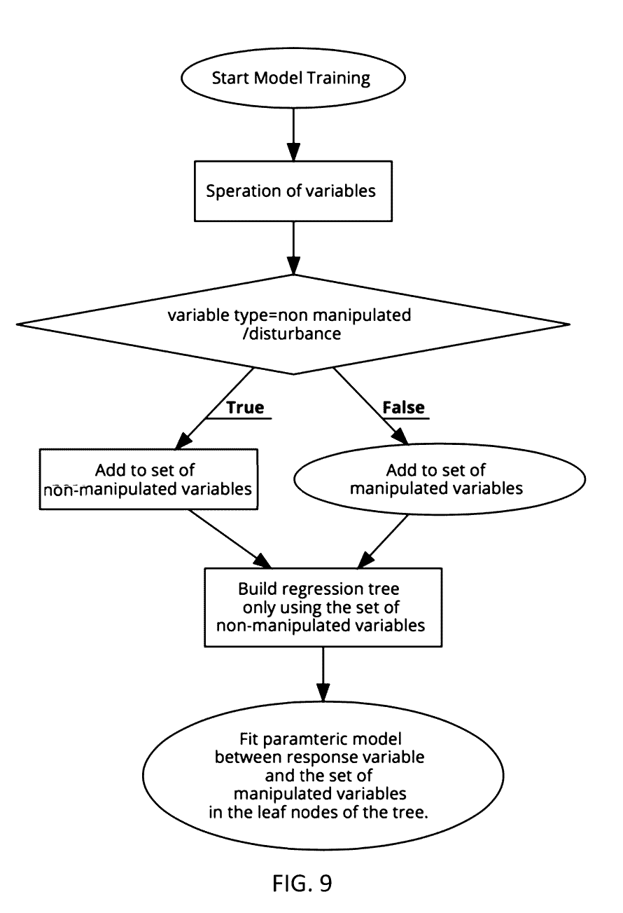

FIG. 9 is a flow chart illustrating using a model based control with regression trees for control synthesis according to an embodiment of the subject matter described herein. FIG. 9 shows how an example model based control with regression trees (mbCRT) method works using the separation of variables principle.

In the case of demand response synthesis for buildings, the response variable is power consumption and the objective function can denote the financial reward of minimizing the power consumption during the DR event. However, the curtailment must not result in high levels of discomfort for the building occupants. In order to account for thermal comfort, in addition to learning the tree for power consumption forecast, we can also learn different trees to predict the temperature of different zones in the building. At each time-step during the DR event, a forecast of the non manipulated variables is used by each tree, to navigate to the appropriate leaf node. For the power forecast tree, the linear model at the leaf node relates the predicted power consumption of the building to the manipulated/control variables [symbol] =β_{0,i}+βᵢ^{T} [symbol] _{c}

Similarly, for each zone [1,2, . . . q] a tree is built whose response variable is the zone temperature Tᵢ. The linear model at the leaf node of each of the zone temperature tree relates the predicted zone temperature to the manipulated variables [symbol] =α_{0,j}+αⱼ^{T} [symbol] _{c}

Therefore, at every time-step, based on the forecast of the non-manipulated variables, we obtain q+1 linear models between the power consumption and q zone temperatures and the manipulated variables. We can then solve the following DR synthesis optimization problem to obtain the values of the manipulated variables [symbol] _{c}:

$${minimize}_{{𝕏}_{c}} f ( k \hat{W} ) + Penalty [ {\sum }_{k = 1}^{q} ( {\hat{T}}_{k} - {T}_{ref} ) ]$$

$$subject to$$

$$k \hat{W} = {β}_{0 , i} + {β}_{i}^{T} {𝕏}_{c}$$

$$\hat{T} 1 = {α}_{0 , 1} + {β}_{1}^{T} {𝕏}_{c}$$

$$…$$

$$\hat{T} d = {α}_{0 , q} + {β}_{q}^{T} {𝕏}_{c}$$

$${𝕏}_{c} ∈ {𝕏}_{safe}$$

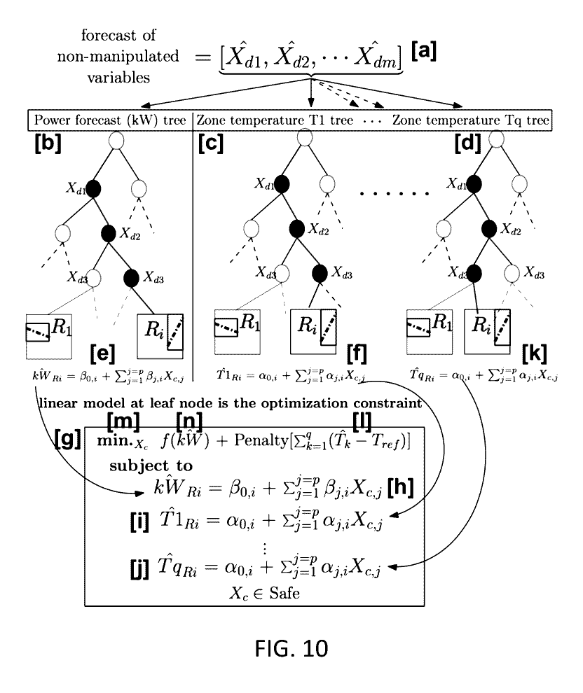

FIG. 10 is a diagram illustrating DR synthesis with thermal constraints according to an embodiment of the subject matter described herein. FIG. 10 shows how an example method for DR using mbCRT based regression trees for power consumption and zone temperature evolution. We first begin with a forecast of non-manipulated variables (FIG. 10[a]). This forecast is used as inputs for the power consumption prediction tree (FIG. 10[b]), and zone temperature prediction tree for each building zone (FIG. 10[c]) and (FIG. 10[d]).

Using the forecast of non-manipulated variables, each tree navigates to the appropriate leaf node, corresponding to the forecast. At the leaf node of each tree, a parametric model exists between the response variable and the manipulated variables (FIG. 10[e]), (FIG. 10[f]) and (FIG. 10[k]). These parametric models are the constraints (FIG. 10[h]), (FIG. 10[i]) and (FIG. 10[j]) for the control optimization (FIG. 10[g]) which is solved to determine the control actions. The objective of the optimization (FIG. 10[g]) is to find a set of control actions which minimize (FIG. 10[m]) the predicted power consumption of the building (FIG. 10[n]) while trying to keep bounded thermal comfort inside the building (FIG. 10[l]).

The intuition behind the mbCRT method is that at run time t, we use the forecast [symbol] of the disturbance features to determine the region and leaf of the top tree and hence, the linear model to be used for the control. We then solve the simple linear program corresponding to that region to obtain the optimal values of the control variables. The mbCRT method is believed to be the first ever method which allows the use of regression trees for control synthesis.

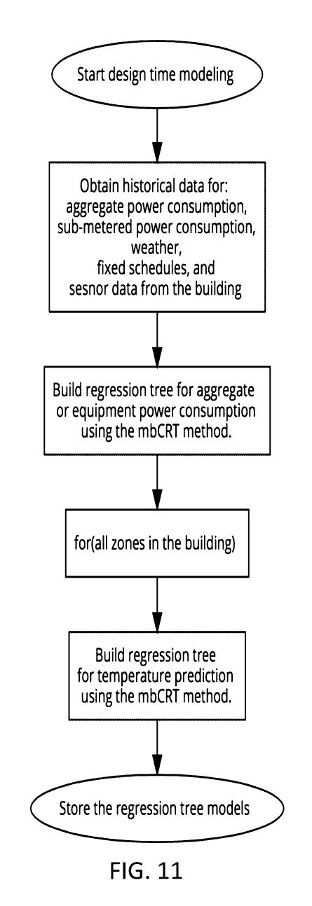

FIG. 11 is a flow chart illustrating a process for control synthesis according to an embodiment of the subject matter described herein. First, in FIG. 11, historical data for aggregate power consumption, sub-metered power consumption, weather, fixed schedules, and/or sensor data from a building may be obtained. Using the obtained information, a regression tree may be built or generated for aggregate or equipment power consumption using an mbCRT method. Also, for all zones in the building, a regression tree may be built or generated for temperature prediction using an mbCRT method. The built regression tree may be stored for later use.

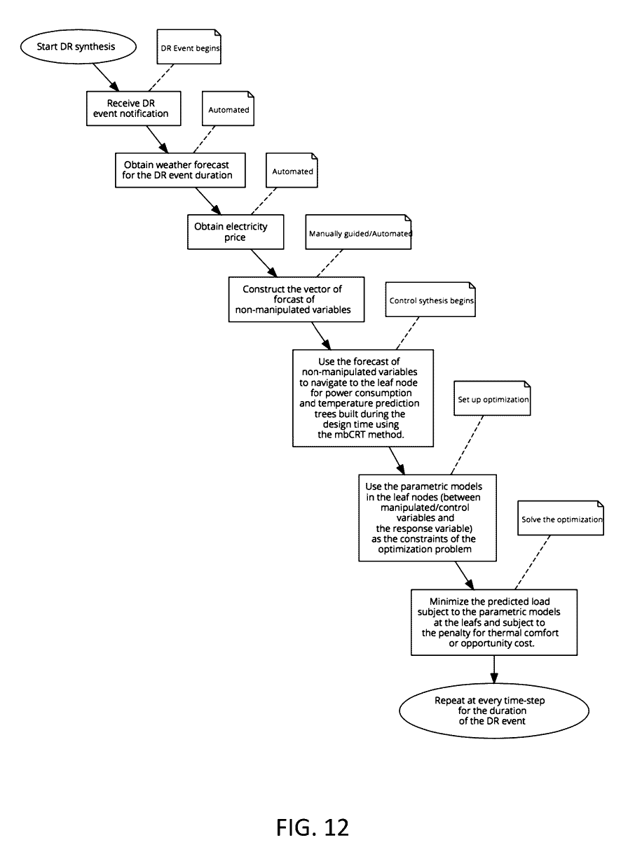

FIG. 12 is a flow chart illustrating a process for DR strategy synthesis according to an embodiment of the subject matter described herein. In FIG. 12, a DR event notification may be received. After a DR event notification is received, a weather forecast may be determined for the DR event duration. Then, electricity pricing may be obtained. Then, a vector of forecast of non-manipulated variable may be constructed. Then, the forecast of non-manipulated variables may be used to navigate to the leaf node for power consumption and temperature prediction trees built during the design time using an mbCRT method. Then, parametric models in the leaf nodes (e.g., between manipulated or control variables and the response variable) may be used as constraints of the optimization problem. Then, a predicted load may be minimized subject to the parametric models at the leaf nodes and subject to the penalty for thermal comfort or opportunity cost.

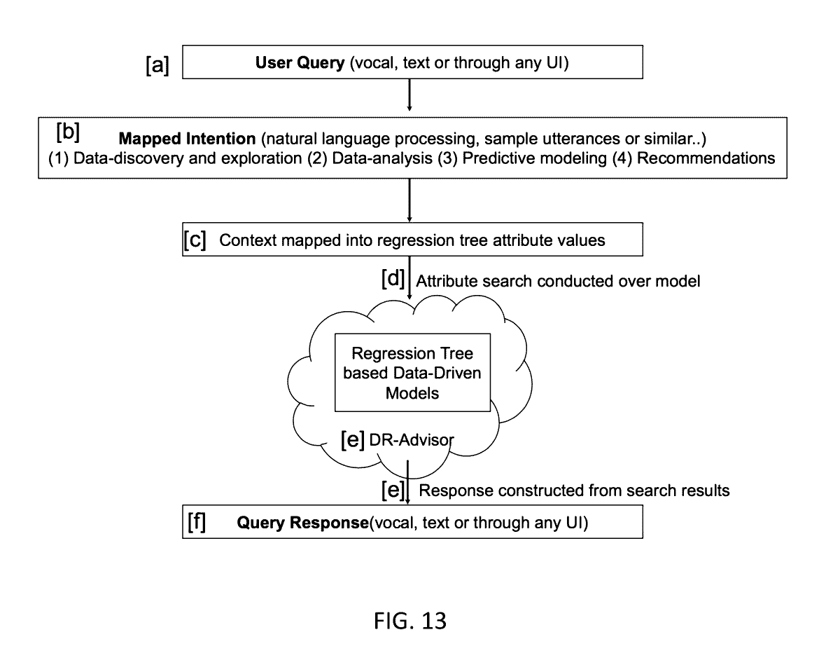

FIG. 13 is a diagram illustrating energy analytics architecture according to an embodiment of the subject matter described herein. Facility managers are demanding more control over their own energy consumption. They prefer insights into performance and usage across their portfolios to make more effective decisions. Implementing energy analytics with regression trees allows one to get near real-time, detailed information about the energy usage. It helps determine if the system is operating efficiently and lets the facilities manager investigate areas for improvement and evaluate energy efficiency upgrades.

Using the underlying regression trees based data-driven models, we can use the models themselves as a knowledge discovery database, capable of providing answers to a large variety of open-ended questions. In some embodiments, DR Advisor or a related system may help answer the questions about the following categories for all participants from end-users to utility companies.

Category of Questions:
1. Data discovery and data exploration: What is happening?
2. Data-analysis: Why did it happen?
3. Predictive modeling: What could happen?
4. Recommendations: What action should be taken?

The following are some more examples of the kind of queries supported by an energy analytics system:
What is the leading cause of peak power consumption of the building compared to the baseline?
Are there any anomalous building electricity consumption patters?
Which buildings on campus consistently consume the most power?
At what time is the peak expected to occur for Building A?
What will be the effect of changing set-point S in building A?
What is the recommended value for set-point S for building A?

Implementing energy analytics using regression trees may involve defining certain attributes (or metadata) for the regression trees which can be later used for mining the regression tree model for answering energy analytics related queries to the system. These attributes help convert the regression tree model into a knowledge database which can be mined for insights and recommendations. Some examples of searchable attributes at the leaf nodes of every regression tree are:
1. Prediction: The prediction value at a leaf node of a tree is the absolute value of the response variable which will be predicted model response Ŷ if the particular leaf node is used for prediction.
2. Support: The support value at leaf node of each regression tree is the ratio of the number of samples which contribute to the leaf node to that of the total number of samples at the root node of the tree.
   a. In other words, the support of a leaf node is a measure of how frequently does the predicted response fall in to the data partition cell defined by that leaf node.
3. Confidence Interval: The confidence interval at a leaf node is the 95% interval around the predicted value of the response variable at that leaf node.

These attributes can be calculated after the tree is built by using the values of the sample data points which fall into the leaf node of each tree. Each attribute specifies a search parameter and changing the value of the attribute determines which rules and branches of the tree are used to answer the high level query in the tree. When the user presents a query in the form of a question, the query is broken down into the user's intent and how it maps to the ‘category of question’ and the context of the query is mapped into a search on the attributes defined for each tree.

Referring to FIG. 13, a user can ask a query (FIG. 13 [a]): under what conditions does the building A consume X kW? First, using pre-defined predicates and sample utterances of queries, the phrase ‘under what conditions’ is mapped to the category: Data discovery and data exploration (FIG. 13 [b]). Next, Building A and X kW are mapped into the attributes to be searched over the regression trees. (FIG. 13 [c]) In this case the search is conducted for those leaves nodes of the regression tree models for building A, which have the prediction attribute equal to X kW. (FIG. 13 [d] and [e]). Finally, the result of the search is converted into a human readable natural language response (FIG. 13 [f]), e.g. Building A consumes X kW usually on Tuesdays, between 1300-1500 hours and when the chilled-water set-point is below 7 degrees Celsius.

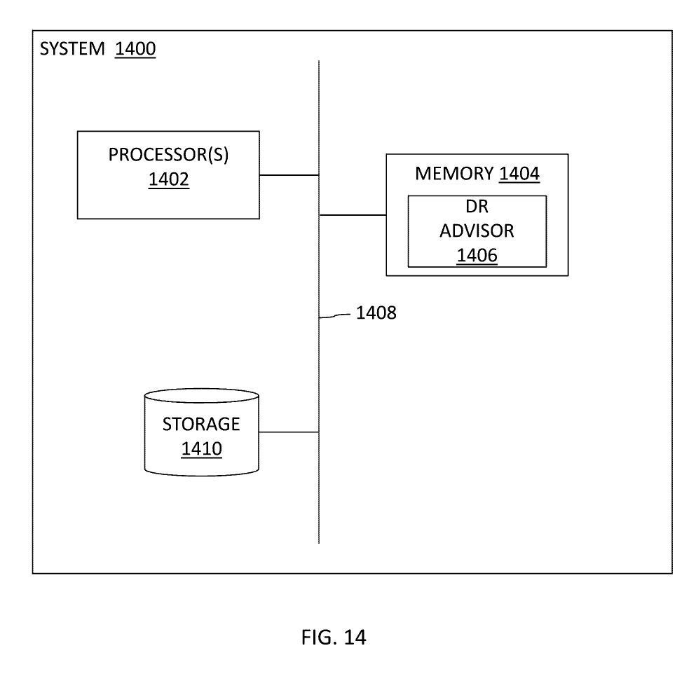

FIG. 14 depicts a high level block diagram of a computer system 1400 suitable for use in performing various functions described herein. For example, computer system 1400 may be a DR advisor or a related system as described herein. In some embodiments, computer system 1400 may be a single device or node or may be distributed across multiple devices or nodes.

As depicted in FIG. 14, system 1400 includes one or more processor(s) 1402, a memory 1404, and storage 1410 communicatively connected via a system bus 1408. In some embodiments, processor(s) 1402 can include a microprocessor, central processing unit (CPU), and/or any other like hardware based processing unit. In some embodiments, a DR advisor engine 1406 can be stored in memory 1404, which can include random access memory (RAM), read only memory (ROM), optical read/write memory, cache memory, magnetic read/write memory, flash memory, or any other non-transitory computer readable medium.

DR Advisor engine 1406 may include logic and/or software for performing various functions described herein. In some embodiments, DR Advisor engine 1406 may include or utilize processor(s) 1402 or other hardware to execute software and/or logic. For example, DR Advisor engine 1406 may perform various functions for performing power (e.g., electricity) consumption predictions and/or for recommending DR related control actions for meeting a required load curtailment during a DR event.

In some embodiments, system 1400 may include one or more communications interfaces to communicate with various entities associated with DR and/or power consumption. Example communications interfaces may use various protocols and may allow various entities to communicate with system 1400 or entities therein (e.g., DR advisor engine 1406). For example, communications interfaces may be used to receive historical electricity usage information, scheduling information, and/or historical weather information associated with a college campus from various sources, e.g., thermostats, computers, databases, climate management systems, HVAC systems, etc.

In some embodiments, processor(s) 1402 and memory 1404 can be used to execute and manage the operation of DR Advisor engine 1406. In some embodiments, storage 1410 can include any storage medium, storage device, or storage unit that is configured to store data accessible by processor(s) 1402 via system bus 1408. In some embodiments, storage 1410 can include one or more local databases hosted by system 1400.

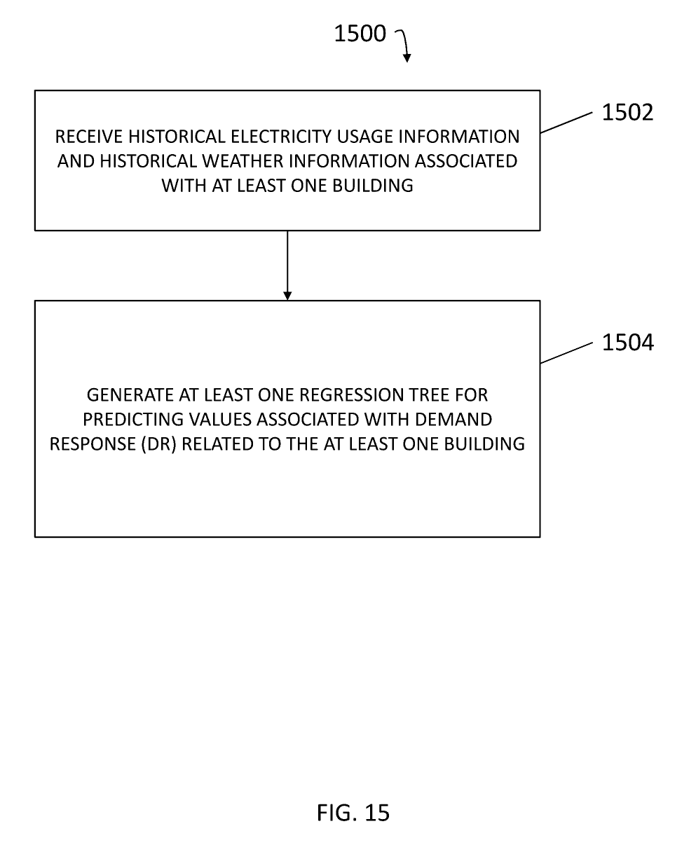

FIG. 15 is a flow chart illustrating a process 1500 for demand response (DR) strategy evaluation according to an embodiment of the subject matter described herein. In some embodiments, process 1500, or portions thereof (e.g., steps 1502 and/or 1504), may be performed by or at a DR Advisor (e.g., DR Advisor 1406), a DR related system (e.g., system 1400), and/or another system, node, or module.

Referring to FIG. 15, at step 1502, historical electricity usage information and historical weather information associated with at least one building may be received. For example, a DR advisor or a related system may receive historical electricity usage information and historical weather information associated with a college campus.

At step 1504, at least one regression tree may be generated for predicting values associated with demand response (DR) related to the at least one building. For example, a set of regression trees may be generated based on received historical electricity usage information, scheduling information, and historical weather information associated with a college campus. In this example, the set of regression trees may predict electricity usage or curtailment based on a variety of factors, including time of day, DR control actions or DR strategies utilized, and/or curtailment needed.

In some embodiments, at least one regression tree for DR related events may be used to perform a DR baseline prediction, a DR strategy evaluation, or a DR strategy synthesis.

In some embodiments, historical electricity usage information may include scheduling or preset information about at least one heating, ventilation, and air-conditioning (HVAC) system associated with the at least one building.

In some embodiments, values associated with DR may include a predefined DR rule, a predefined strategy, a dynamic DR rule, a dynamic DR strategy, a DR control action, a zone temperature set-point, a supply air temperature set-point, a chilled water temperature set-point, a lighting intensity value, a duct static pressure set-point, and a supply fan operation value.

In some embodiments, at least one regression tree may be generated using a CART algorithm, a cross validated CART algorithm, a boosted regression tree algorithm, a random forest algorithm, or a model based regression tree algorithm.

In some embodiments, performing a DR baseline prediction may include predicting an amount of electricity consumed in the absence of a DR event using the at least one regression tree.

In some embodiments, performing a DR strategy evaluation may include predicting electricity curtailment for a predetermined DR strategy.

In some embodiments, performing a DR strategy synthesis may include determining a set of DR control actions for implementing electricity curtailment.

In some embodiments, performing a DR analytics response may include receiving, from a user, an open-ended query related to DR, generating, using the at least one regression tree, a response to the query, and providing the response to the user.

The disclosure of each of the following references is incorporated herein by reference in its entirety.

### REFERENCES

Federal Energy Regulatory Commission and others. (2012). Assessment of demand response and advanced metering.
Goldman, C. (2010). Coordination of energy efficiency and demand response. Lawrence Berkeley National Laboratory.
Kormos, M. J. (2014). PJM response to consumer reports on 2014 winter pricing. PJM Interconnection.
LCG Consulting. (n.d.). PJM. Retrieved Oct. 15, 2015, from Energy Online: PJM Real-Time Pricing Archives: http://tinyurl.com/pjmsummer
Melillo, J. M. (2014). Climate change impacts in the United States: the third national climate assessment. US Global change research program, 841.
Mulhall, R. A. (2014). Energy price risk and the sustainability of demand side supply chains . Applied Energy , 123 (0), 327-334.
Navigant Research. (2015). Demand Response for Commercial & Industrial Markets Market Players and Dynamics, Key Technologies, Competitive Overview, and Global Market Forecasts.
NOAA National Centers for Environmental Information. (2015, Sep. 15). State of the Climate: Global Analysis for August 2015. Retrieved Oct. 15, 2015, from NOAA: http://www.ncdc.noaa.gov/sotc/global/201508

D. B. Crawley, L. K. Lawrie, et al., Energyplus: creating a new-generation building energy simulation program, Energy and Buildings 33 (4) (2001) 319-331.
PJM Interconnection. (2014). 2014 Demand Response Operations Markets Activity Report.
Sturzenegger, D. A. (2015). Model Predictive Climate Control of a Swiss Office Building: Implementation, Results, and Cost-Benefit Analysis. IEEE Transactions on Control Systems Technology.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A system comprising:
at least one processor; and
a memory, wherein the system is configured to receive historical electricity usage information and historical weather information associated with at least one building, to generate at least one regression tree for predicting values associated with demand response (DR) related to the at least one building.

2. The system of claim 1 wherein the system is configured to perform, using the at least one regression tree, a DR baseline prediction, a DR strategy evaluation, a DR strategy synthesis, or energy analytics.

3. The system of claim 1 wherein the historical electricity usage information includes scheduling or preset information about at least one heating, ventilation, and air-conditioning (HVAC) system associated with the at least one building.

4. The system of claim 1 wherein the values associated with DR include a predefined DR rule, a predefined DR strategy, a dynamic DR rule, a dynamic DR strategy, a DR control action, a zone temperature set-point, a supply air temperature set-point, a chilled water temperature set-point, a lighting intensity value, a duct static pressure set-point, and a supply fan operation value.

5. The system of claim 1 wherein the system is configured to generate the at least one regression tree using a classification and regression tree (CART) algorithm, a cross validated CART algorithm, a boosted regression tree algorithm, a random forest algorithm, or a model based regression tree algorithm.

6. The system of claim 2 wherein the system is configured to perform the DR baseline prediction by predicting an amount of electricity consumed in the absence of a DR event using the at least one regression tree.

7. The system of claim 2 wherein the system is configured to perform the DR strategy evaluation by predicting electricity curtailment for a predetermined DR strategy.

8. The system of claim 2 wherein the system is configured to perform the DR strategy synthesis by determining a set of DR control actions for implementing electricity curtailment.

9. The system of claim 2 wherein the system is configured to perform energy analytics by receiving, from a user, an open-ended query related to DR, generating, using the at least one regression tree, a response to the open-ended query, and sending the response to the user.

10. A method, the method comprising:
receiving historical electricity usage information and historical weather information associated with at least one building;
generating at least one regression tree for predicting values associated with demand response (DR) related to the at least one building.

11. The method of claim 10 comprising:
performing, using the at least one regression tree, a DR baseline prediction, a DR strategy evaluation, a DR strategy synthesis, or energy analytics.

12. The method of claim 10 wherein the historical electricity usage information includes scheduling or preset information about at least one heating, ventilation, and air-conditioning (HVAC) system associated with the at least one building.

13. The method of claim 10 wherein the values associated with DR include a predefined DR rule, a predefined DR strategy, a dynamic DR rule, a dynamic DR strategy, a DR control action, a zone temperature set-point, a supply air temperature set-point, a chilled water temperature set-point, a lighting intensity value, a duct static pressure set-point, and a supply fan operation value.

14. The method of claim 10 wherein the at least one regression tree is generated using a classification and regression tree (CART) algorithm, a cross validated CART algorithm, a boosted regression tree algorithm, a random forest algorithm, or a model based regression tree algorithm.

15. The method of claim 11 wherein performing the DR baseline prediction includes predicting an amount of electricity consumed in the absence of a DR event using the at least one regression tree.

16. The method of claim 11 wherein performing the DR strategy evaluation includes predicting electricity curtailment for a predetermined DR strategy.

17. The method of claim 11 wherein performing the DR strategy synthesis includes determining a set of DR control actions for implementing electricity curtailment.

18. The method of claim 11 wherein performing energy analytics includes receiving, from a user, an open-ended query related to DR, generating, using the at least one regression tree, a response to the open-ended query, and providing the response to the user.

19. A non-transitory computer readable medium having stored thereon executable instructions that when executed by a processor of a computer cause the computer to perform steps comprising:
receiving historical electricity usage information and historical weather information associated with at least one building; and
generating at least one regression tree for predicting values associated with demand response (DR) related to the at least one building.

20. The non-transitory computer readable medium of claim 19 having stored thereon executable instructions that when executed by the processor of the computer cause the computer to perform, using the at least one regression tree, a DR baseline prediction, a DR strategy evaluation, a DR strategy synthesis, or energy analytics.
